(19) United States
(12) Patent Application Publication
(10) Pub. No.: US 2024/0405616 A1
(43) Pub. Date: Dec. 5, 2024

(54) Low Profile Motor Using Permanent Magnets

(71) Applicant: US Positronix Inc., Oberlin, OH (US)

(72) Inventors: Remigio Perales, Oberlin, OH (US); Clifford J.P. Gilman, New Castle, NH (US); Simon A. Perales, Oberlin, OH (US)

(21) Appl. No.: 18/735,136

(22) Filed: Jun. 5, 2024

Related U.S. Application Data
(60) Provisional application No. 63/506,355, filed on Jun. 5, 2023.

(51) Int. Cl. H02K 1/17; H02K 1/2793; H02K 51/00

(52) U.S. Cl. CPC H02K 1/17; H02K 1/2793; H02K 51/00

(57) ABSTRACT

A high torque, dimensionally flexible motor is powered by actuated magnets on a stator interacting with permanent magnets on a rotor. The stator actuated magnets move towards and away from the rotor magnets, creating repulsive and/or attractive forces to spin the rotor and its shaft. Spinning and reciprocating configurations include rotor over stator, stator over rotor, rotor inside stator, and stator inside rotor. Such a motor provides high torque and has preferential dimensions and shapes for space constrained applications such as those requiring small height and large radius, or a long thin rectangular footprint. A rotor can be made to spin both clockwise and counter-clockwise, at different times, in the same configuration.

### BACKGROUND OF THE INVENTION

The fundamental principles of electric motors have been understood since the mid-18th century, with working demonstrations being performed in the early 1800's before becoming practically useful later that century. Today, electric motors are used extensively in a wide variety of applications and account for about 50% of global electrical energy consumption. Generally, these motors are comprised of a rotor (rotates and delivers the mechanical power), bearings (fixed to the motor casing which allow the rotor to spin), and stator (remains stationary producing a magnetic force which causes the rotor to move as desired). In motors which use coil windings as the primary driving force (almost all motors on the market), creatively designed armatures can be integrated to aid with efficient operation by orienting the coils to produce more effective magnetic repulsive forces.

In the vast majority of electric motors, electromagnets comprised of coil windings are directly involved in the force between the rotor and stator which produces the mechanical power. This allows for precise control and timing of the driving magnetic forces, but also produces a host of problems which include but are not limited to: wearing on brushes and commutator involved in contact required to complete the circuit powering the electromagnets; high weight of coils to produce electromagnets with sufficient strength to generate desired torque; high power consumption to produce electromagnets with sufficient strength to generate desired torque; cogging; overheating; and complications of complex electromagnetic functioning (eddy current losses, magnetic saturation, etc.). Some improvements have been made, most notably the development of brushless motors made possible by advancements in solid state electronics in the 1960's. However, while brushless motor technology does evade issues involving wear on the commutator and brushes, the relatively high cost, weight, and heat production of brushless motors has prevented its ubiquitous use.0003] We observe that few low profile motors are available on the market. By low profile, we mean that the height (thickness) of the motor along the axis of the shaft is minimized.

The problems listed above present an opportunity for a new motor technology. Various use cases, which require high torque and low weight, include unmanned underwater vehicles, medium to large electric aircraft, aerospace pumps/vacuum, aerospace directive antenna, aerospace multiaxial gimbaling mechanisms (control moment gyroscopes), reaction wheel assemblies and integrated motor assist (automotive). Furthermore, immediate, high-torque, multi-directional rotational motion is necessary for applications such as rotary axis inspection positioning systems, machine tooling and associated tool changers, metrology, simulators (flight control, etc.), and various robotics applications such as manufacturing and packaging.

### BRIEF SUMMARY OF THE INVENTION

The working principle of the invention (the motor), as generally described in previous patent application PCT/US2021/045457, primarily involves the repulsion between permanent magnets to drive the motor. This differs from existing known practical electric motors because no electromagnets are used directly in the driving force; only permanent magnets are involved in the repulsive forces interacting between the rotor and the stator. This driving mechanism has multiple advantages including reduced weight, reduced wear and thus maintenance, and increased torque capabilities. Furthermore, this driving mechanism allows for the motor to have a very low profile, defined as a motor with a small thickness, or small height parallel to the axis of the rotor, which can be beneficial for certain applications where available space is constrained, especially in the direction of the axis of rotation.

The embodiment described in PCT/US2021/045457 and shown in its FIG. 13B is made up of a bed of linearly actuated permanent magnets which can individually move up and down with a common polarity facing upwards, as well as a group of permanent magnets oriented with the same polarity facing downwards, which are mounted on the underside of a spinnable structure above, so that when an actuated magnet moves up and closer to the mounted spinnable magnets, it exerts repulsive magnetic forces. The actuated magnets are precisely lifted up in relation to the position and movement of the mounted spinnable magnets, causing the spinnable structure to rotate. The spinning structure exerts torque on a shaft, causing it to spin, and thus imparting motive power. The bed of actuated magnets acts as a stator, and the spinnable structure acts as a rotor.

The spinnable structure (rotor), including its magnets, can have a small axial thickness, and it can be configured to have whatever radius/diameter is appropriate for the amount of torque needed and lateral space available.

The bed of actuated permanent magnets (stator) can be configured in a ring that corresponds to the radius of the arc or circular path through which the magnet(s) positioned on the spinnable structure (rotor) travel. The rotor can have permanent magnets positioned at multiple radii. Likewise, the stator can be configured with multiple separate rings of actuated magnets, each ring corresponding to the radius of one of the paths of permanent magnets on the rotor. The stator structure can have a small axial thickness, and the combined stator and rotor structures can have a small axial thickness.

The rotor can be configured to trace an elliptical or rounded rectangular path, rather than a circular one, for example using arms with adjustable radius length based upon the arm's location in its spin path. Each arm can adjust to a longer (greater) radius while spinning through and located in a first arc region, and to a shorter (lesser) radius while spinning through and located in a second arc region.

The rotor can be configured to trace a non-planar 3D surface, with the stator configured in a geometrically similar surface, with the stator magnets facing the rotor magnets as they travel in their paths.

The rotor can alternatively be a roller chain which drives the shaft through a sprocket or gear mechanism. Using this structure, the stator and rotor can be configured into a variety of shapes.

In a related embodiment, a reciprocating configuration replaces the spinning configuration. Instead of spinning around a full circular path, each part of the rotor travels in a first direction in a finite arc, being pushed by the stator magnets, which are configured in a plane parallel to the plane of the rotor magnets, in an arc path that corresponds to the entire arc path of travel of the rotor magnets. While being pushed in this first direction, the reciprocating rotor exerts torque on the shaft. When the rotor reaches the end of its configured arc, it disengages the shaft, allowing the shaft to continue to spin with its angular momentum, and the rotor returns to the beginning of its configured arc. The return motion can be effected by the stator magnets, or there can be a return mechanism like a spring, pneumatic device, elastic band or gravity based mechanism. The rotor is then pushed again in the first direction, engaging the shaft, and exerts torque on the shaft through its arc, then disengages and returns to its original position, and the process repeats over and over. This configuration allows for a motor of both small thickness and also small width, and an almost unlimited range of lengths, while employing less magnetic material than is needed for a full circular path.

Each of the above-described embodiments assume that a stator is placed underneath (beside) the spinnable or reciprocating rotor and the stator magnets actuate upwards/towards and downwards/away from the magnets of the spinning/reciprocating rotor, creating repulsive/pushing forces. The configuration can be altered so that the magnets are in the same structural positions, but the polarity of either the stator or rotor magnets is reversed, so that attractive/pulling force is used to drive the spinning/reciprocating motion. Further, the configuration of rotor vs. stator can be flipped, so that the stator actuated magnets actuate downwards/towards and upwards/away from the spinning/reciprocating rotor magnets, which are mounted on top of the rotor structure. The polarity of the magnets can be configured for attractive/pulling force or repulsive/pushing force.

In another embodiment, the spinnable structure (rotor) with permanent magnets is configured such that its permanent magnets expel a field of one polarity on a first surface of the structure, and expel a field of the opposite polarity on a second, opposite facing surface. Stators with actuated permanent magnets are configured on either side of the spinning rotor (such as above and below). One set of stator magnets actuates upwards, and the second set with stator magnets of opposite polarity actuates downwards, thereby creating the repulsive/attractive forces on both sides of the rotor. Alternatively, the rotor can have permanent magnets affixed to both sides of its structure (opposing faces), rather than the same magnets exposed on two opposing faces.

In any of these embodiments, the rotor permanent magnets affixed to the spinnable/reciprocating structure can be angled relative to the face of the spinning structure, such that the forces from the actuated magnets create maximum angular forces/acceleration/momentum. Furthermore, the stator actuating permanent magnets can also be angled to increase torques along the axis of rotation.

Mu metal can be configured either on the surface or within the spinnable/reciprocating structure or between actuating magnets, to limit unwanted forces between the rotor permanent magnets and stator actuating magnets that would otherwise result in decelerating forces.

In another embodiment, stator actuated magnets are located in a circle in the plane of and outside of a spinning structure/rotor, and actuate radially inward toward the rotor. The rotor has magnets mounted on its perimeter, facing toward the stator ring of actuated magnets. The stator actuated magnets exert repulsive or attractive forces on the spinning rotor's magnets, by moving towards and away, causing the rotor structure and attached shaft to spin.

In another embodiment, stator actuated magnets are located in a circle inside of a spinning structure/rotor, and actuate radially outward toward the rotor. The rotor has a ring of magnets mounted on its inner perimeter/surface, facing inward toward the stator ring of actuated magnets. The stator actuated magnets exert repulsive or attractive forces on the spinning rotor magnets, by moving towards and away, causing the rotor structure and attached shaft to spin.

This perimeter magnet arrangement can be used with a reciprocating structure. It can be used with a spinning structure with adjustable radius. It can be implemented as a stepper motor.

Stator magnets can be actuated using linear actuators, rotary actuators, a combination thereof, or other actuation structures and methods. Stator electromagnets can be added to provide greater speed and precision. Combinations of actuator types and electromagnets may be used together as part of the same stator.

The stator magnets can be actuated using a preprogrammed timing method, a feedback method, or machine learning methods.

### BRIEF DESCRIPTION OF THE SEVERAL VIEWS OF THE DRAWINGS

FIG. 1A is a bottom view of a fan shaped rotor with one ring of permanent magnets facing downwards.

FIG. 1B is an isometric view of the rotor of FIG. 1A.

FIG. 2 is a top view of a stator with one ring of permanent actuated magnets facing upwards.

FIG. 3 is an isometric view of the FIG. 1 rotor and FIG. 2 stator in over/under position relative to each other.

FIG. 4A is a detail view of stator magnets shown in FIG. 3, showing combined permanent magnets and electromagnets.

FIG. 4B is a detail view of alternate stator magnets shown in FIG. 3, showing the combined permanent magnets and electromagnets mounted on linear actuators.

FIG. 4C is a detail view of alternate stator magnets shown in FIG. 3, showing tilted permanent magnets.

FIG. 4D is a detail view of alternate stator magnets shown in FIG. 3, showing multiple permanent magnets mounted on a single linear actuator.

FIG. 5 is a bottom view of a spoke shaped rotor with multiple rings of permanent magnets facing downwards.

FIG. 6 is a top view of a stator with multiple rings of permanent actuated magnets facing upwards, configured to work in an over/under configuration with the FIG. 5 rotor.

FIG. 7 is an isometric view of a disk shaped rotor with one ring of permanent magnets facing downwards.

FIG. 8A is a top view of an inner/outer configuration, showing a rotor with circumferentially configured permanent magnets facing outwards towards a stator of circumferentially configured actuated permanent magnets facing inwards.

FIG. 8B is an isometric view of the rotor and stator of FIG. 8A.

FIG. 9 is an isometric view of an inner/outer configuration similar to that shown in FIGS. 8A and 8B, but showing an axially taller rotor and stator, with more stator magnets and more rotor magnets.

FIGS. 10A and B show two simplified side views of a permanent magnet mounted on a linear actuator, at different levels of actuation.

FIG. 10C shows a side view of a more realistic and detailed linear actuator.

FIGS. 11A and 11B are isometric views of two permanent magnets mounted on the curved surface of a simplified rotary actuator, with the magnets at different rotation locations in each view.

FIGS. 12A and 12B show a permanent magnet mounted on a shaft beside a simplified rotary actuator, which allows the magnet to flip. The permanent magnet is shown at different rotations in each view.

FIGS. 13A-13C show side views of a rotor section with a rotary actuator beneath, in an over/under configuration. FIG. 13A shows a stator magnet attracting the rotor magnet; FIG. 13B shows the stator magnet moving away from the rotor, so as not to reduce its momentum, and FIG. 13C shows a stator magnet repelling the rotor magnet, thus pushing it away.

FIG. 14 shows a top partial view of an outer/inner configuration, with rotary actuators being used for the surface-mounted stator magnets.

FIG. 15 is a bottom view of a reciprocating rotor with two arms, configured to travel in an arc path with a shaft as the axis.

FIGS. 16A-C are isometric views of a reciprocating rotor with one arm, and stator magnets configured above, to apply torque to the rotor magnets. FIG. 16A shows the rotor being pushed clockwise by stator magnets; FIG. 16B shows the rotor beginning to return to its initial position by the return mechanism (not shown); and FIG. 16C shows the rotor continuing to its initial position.

FIG. 17 is an isometric view of a rotor made up of permanent magnets attached to a chain, which applies torque to a shaft, paired with a set of stator magnets configured above to apply force to the rotor magnets.

FIG. 18 is an isometric view of the underside of a disk-shaped rotor with permanent magnets set at angles to the rotor's flat underside.

FIG. 19 is a top view of an exemplary outer/inner configuration, where the rotor has circumferentially positioned permanent magnets facing inward toward a stator module, which has actuated permanent magnets set at angles to the cylindrical stator's curved surface.

FIG. 20 is an isometric view of the outer/inner rotor/stator configuration shown in FIG. 19.

FIG. 21 is a side view of a conical rotor and conical stator.

### DETAILED DESCRIPTION OF THE INVENTION

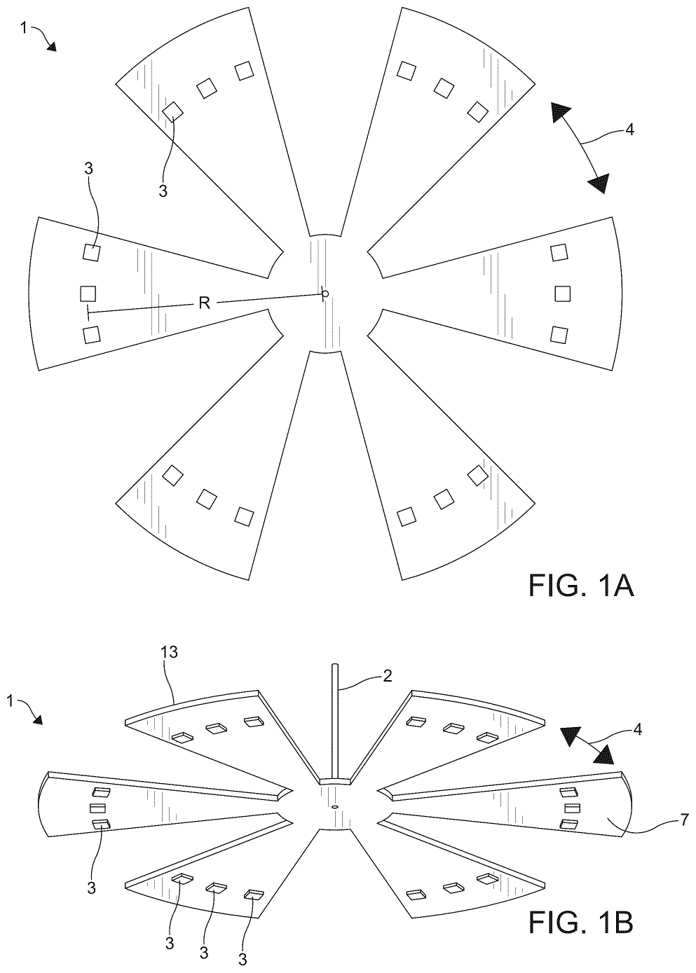

In the motor embodiment shown in FIGS. 1A, 1B, 2 and 3, a rotor 1 is suspended at the bottom end of a vertical shaft 2 placed at the center of the rotor, and one or more permanent magnets 3 are attached to the underside 7 of the rotor, at radius R. A modular stator 5 is located directly underneath the rotor 1, with one or more actuated permanent magnets 6 located underneath and along each circular path with radius R where rotor magnet(s) 3 travel when the rotor 1 spins on the shaft 2. The plane of rotor magnets is parallel to the plane of stator magnets. We refer to this as an over/under configuration of rotor (over) and stator (under).

Each configuration herein described and illustrated has a shaft connected to a rotor. The shaft can be used to power a mechanical machine, engine, motor, or generator. The shaft can be directly connected to components and used to directly to spin a fan blade, wheel or any other structure, or it can be connected to another component through a gearing mechanism. The invention can be used to spin the shaft for whatever purpose is desired, although those structures and purposes are not illustrated herein.

FIG. 1B shows the rotor magnets 3 protruding from the rotor's underside 7. They could also be attached in a manner which makes them flush with the bottom surface 7 of the rotor.

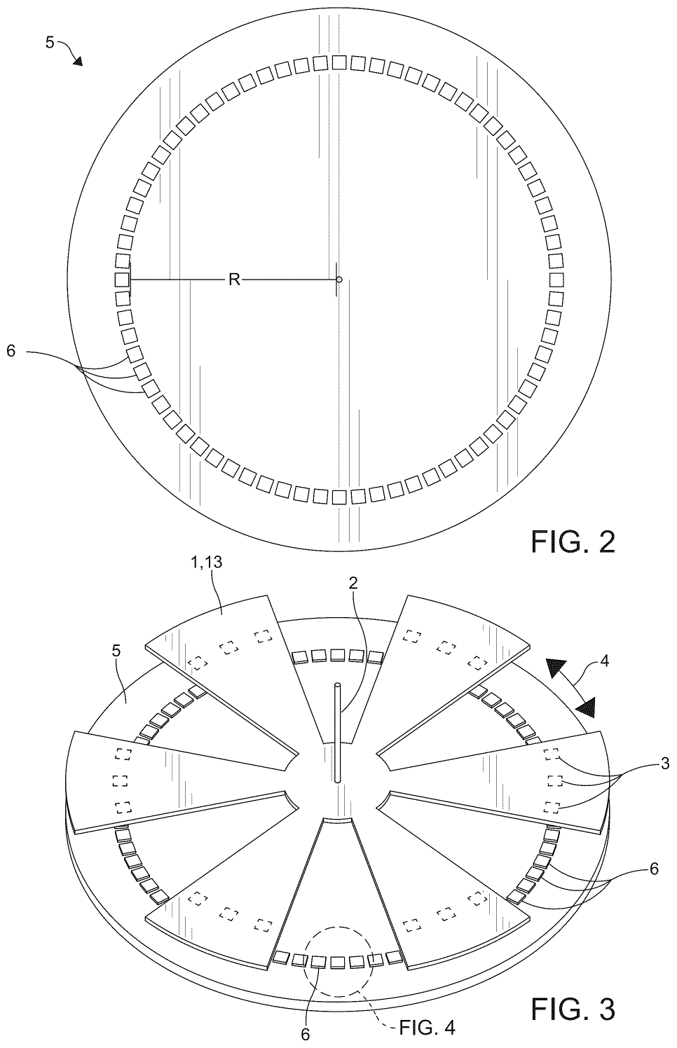

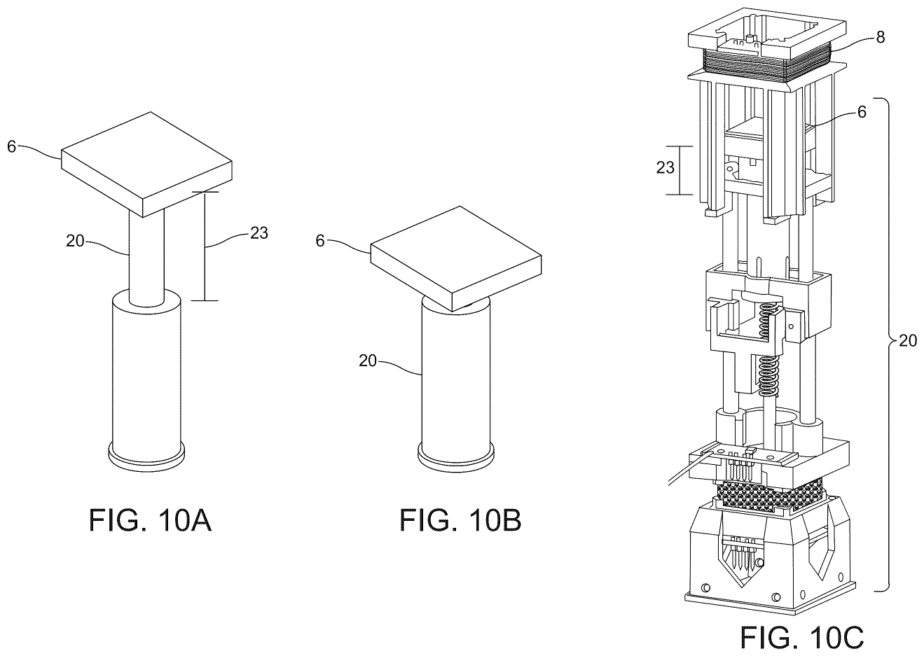

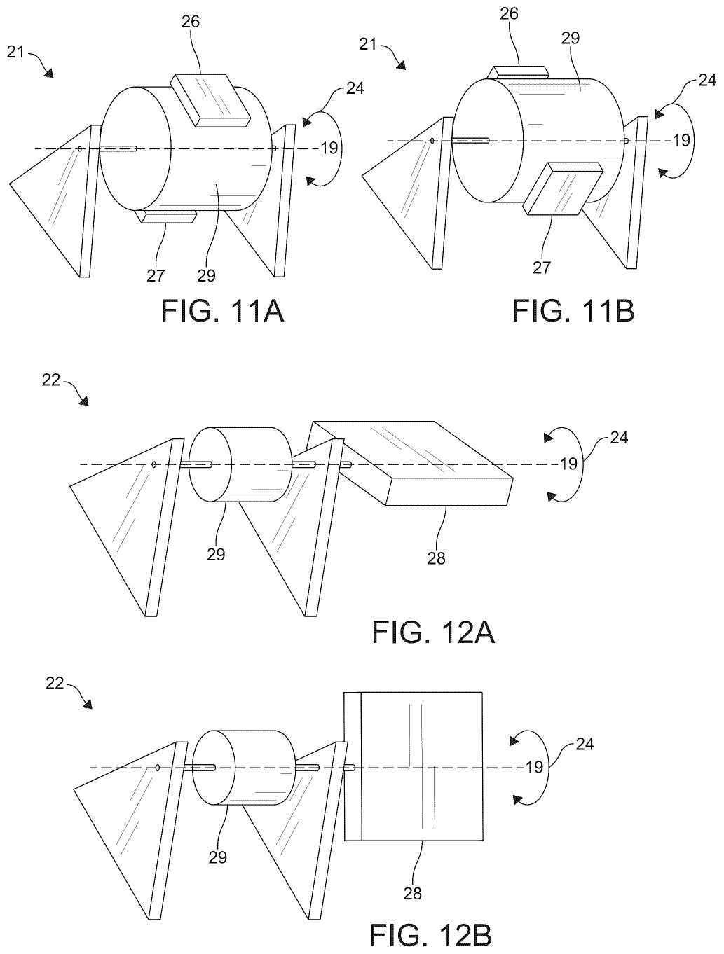

FIGS. 2 and 3 show the stator magnets 6 without details of actuation. The stator magnets can be actuated with linear actuators 20, as shown in FIGS. 9A, 9B and 9C; they can be mounted on the curved surface of rotary actuators 21 as shown in FIGS. 10A and 10B; they can be mounted on the extended axis of rotary actuators 22 as shown in FIGS. 11A and 11B; or they can function via a pneumatic mechanism, a hydraulic mechanism, spring action, electroactive polymer, electromagnet actuation, electrostatic actuation, combustion, steam drive mechanism, or actuation capabilities of some other method or structure, or combination of any of these or other methods or structures.

In a repulsion embodiment, the polarity pointing downwards from the rotor magnets 3 is the same as the polarity pointing upwards from the stator magnets 6, such that when a stator magnet is actuated to be close enough to a rotor magnet for the magnetic fields to interact, magnetic repulsion pushing forces and torques are created. Considering the configuration where the rotor magnets are constrained to a circular XY planar path of radius R, then depending upon the relative positions of each stator magnet and rotor magnet, magnetic repulsion can push the rotor magnet in a clockwise direction along its path, or in a counter-clockwise direction. Precise actuation timing and positioning create magnetic repulsion between stator and rotor magnets, which causes the desired lateral force on the rotor magnets 3, which translates into the desired torque acting on the rotor 1, causing the rotor structure to spin on its shaft 2 in a clockwise or counter-clockwise direction 4, and to accelerate or decelerate in the clockwise or counter-clockwise direction.

In an attraction embodiment, the polarity pointing downwards from the rotor magnets 3 is opposite to the polarity pointing upwards from the stator magnets 6, such that when a stator magnet is actuated to be close enough to a rotor magnet for the magnetic fields to interact, magnetic attractive pulling forces and torques are created. Precise actuation timing and positioning create magnetic attraction force between stator and rotor magnets, which causes linear lateral force on the rotor magnets, which translates into torque acting on the rotor, causing the rotor structure to spin on its shaft 2 in a clockwise or counter-clockwise direction 4.

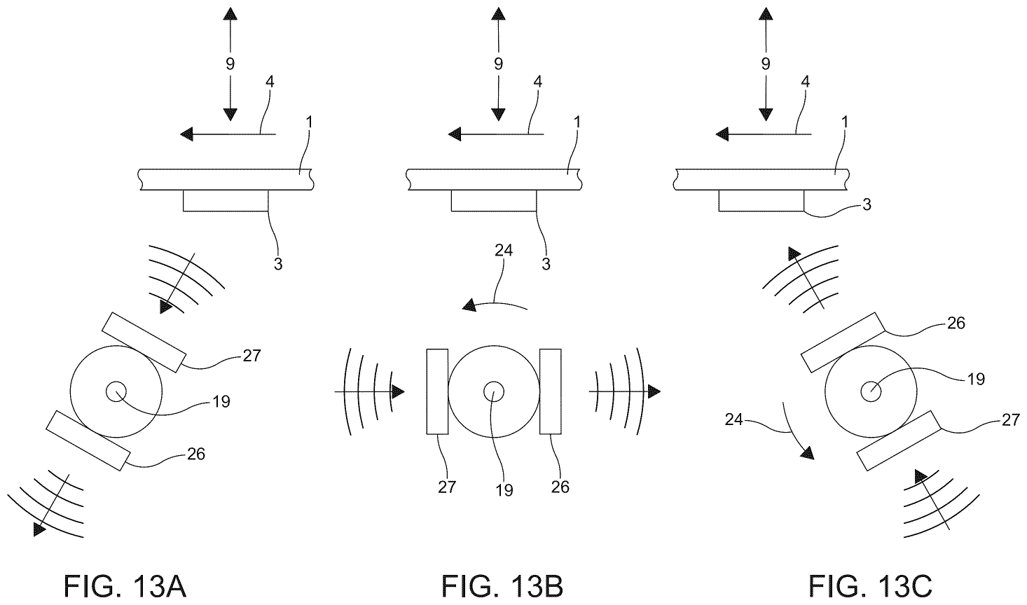

In a pull/push embodiment, stator magnets 6 mounted on rotary actuators 21 as shown in FIGS. 10A and 10B or mounted on shafts 30 beside rotary actuators 22 as shown in FIGS. 11A and 11B can interact with rotor magnets 3 with attraction at some times and repulsion at other times. For example, as the rotor 1 rotates and a rotor magnet 3 approaches a stator actuated magnet 6, the stator magnet 26 is of opposite polarity, and attracts or pulls the rotor magnet 3, see FIG. 13A. As the rotor magnet passes over the stator magnet, the stator actuator begins an action to eventually reverse the polarity, either by rotating the opposite polarity magnet 26 away and a same polarity magnet 27 in the direction of rotor rotation, see FIG. 13B, pushing the rotor magnet 3 laterally with repulsive force, see FIG. 13C; or rotating the side shaft-mounted stator magnet 28 180 degrees on a central axis parallel to the rotor radius R, rotating the same-polarity side of the stator magnet 28 away from the rotor and the opposite polarity side of the stator magnet 28 to face the rotor, similarly pushing the rotor magnet 3 laterally with magnetic repulsive force. These interactions cause torque to act on the rotor 1, and thus the shaft 2 spins in a clockwise or counter-clockwise direction 4.

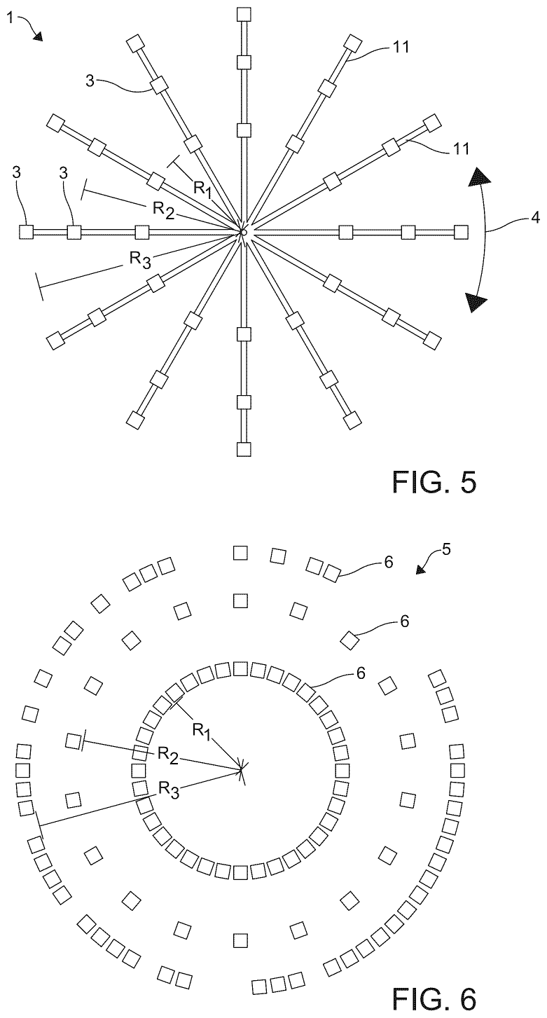

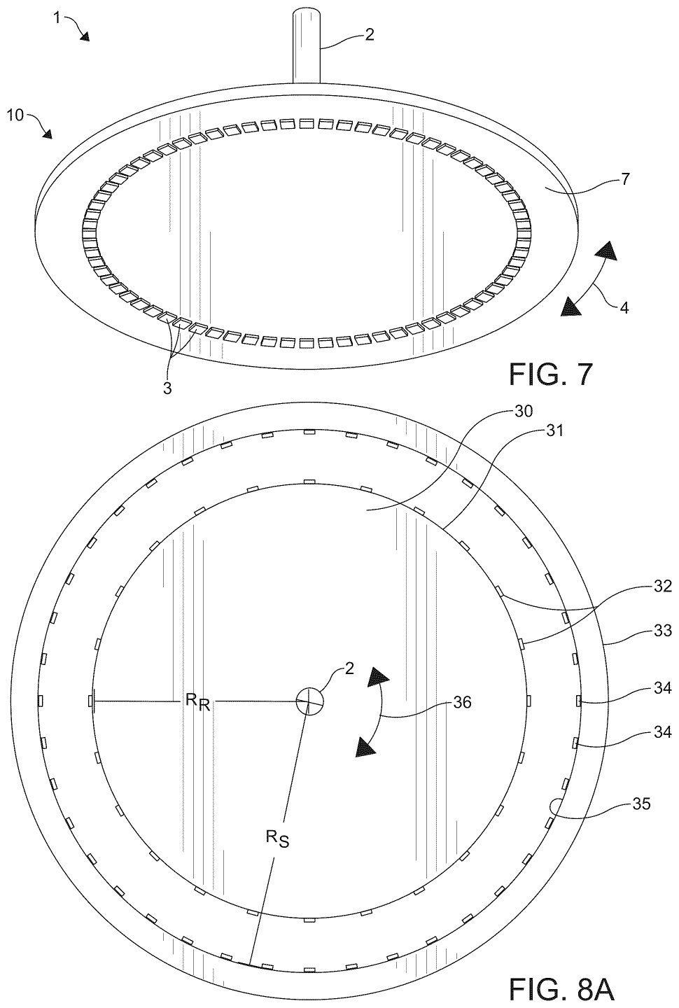

FIGS. 1A, 1B and 3 show the rotor's spinnable structure to be fan shaped, with blades 13. The rotor can alternatively be a disk 10, as shown in FIG. 7, or any number of spokes 11 as shown in FIG. 5, with or without polar symmetry, or rings mounted on spokes, or one spoke or blade, or two spokes or blades opposite each other, or any symmetrical or asymmetrical configuration.

FIGS. 5 and 6 show a spoke shaped rotor 1 with magnets 3 attached underneath the rotor's bottom surface 7, and located at multiple radii R₁, R₂ and R₃ from the central shaft 2, and stator magnets 6 located at the same radii R₁, R₂ and R₃ in the configuration. Lateral spacing and number of rotor magnets 3 can match those of the stator magnets 6, or spacing can differ, or number of rotor magnets can exceed stator magnets, or number of stator magnets can exceed rotor magnets.

An over/under configuration can be flipped to be under/over, with the stator 5 on top, and rotor 1 underneath. Stator linear actuators 20 would move downwards to approach the rotor magnets 3. The over/under configuration can be tilted 90 degrees, so that the rotor and stator planes are both vertical. The over/under configuration can be tilted any number of degrees, to form a tilted over/under configuration, or a tilted under/over configuration.

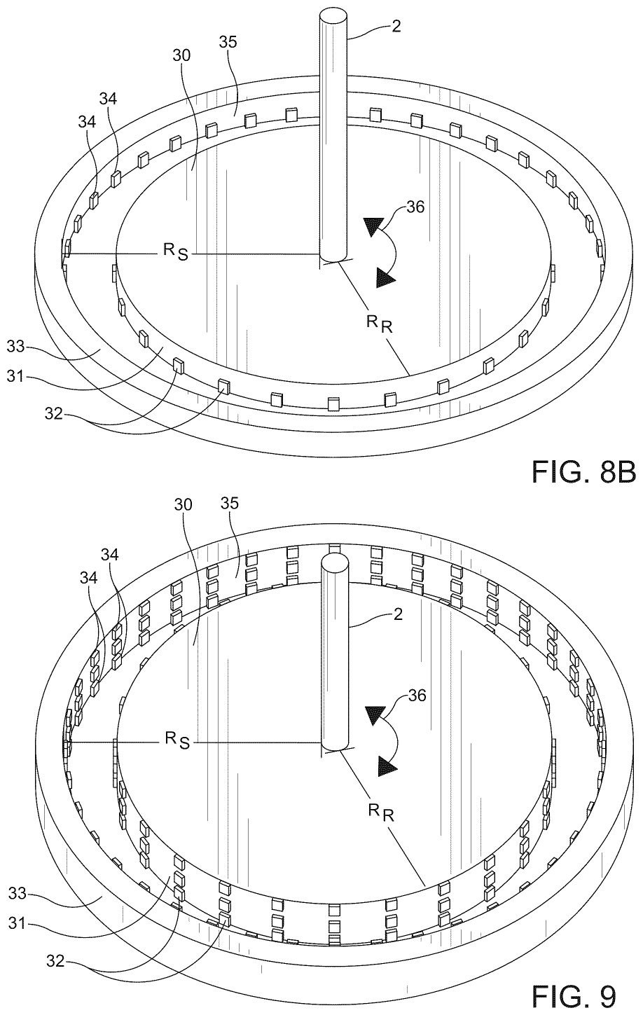

FIGS. 8A, 8B and 9 show an inner/outer configuration, with the rotor magnets 32 located on the perimeter 31 of the rotor 30 disk, or ends of fan blades or spokes, or on the curved surface 31 of the rotor cylinder, at radius Rr, with polarity of each rotor magnet 32 facing radially outwards. The stator 33 encircles the rotor, with actuated magnets 34 located radially outside of the circular path of the rotor magnets 32, at radius Rₛ and inside of the stator surface 35. The stator actuated magnets move in relation to the magnets 32 on the rotor perimeter 31, causing lateral forces so that the rotor 30 spins in a clockwise or counter-clockwise direction 36, and imparts torque to the shaft 2. The rotor 30 can be configured and pushed to spin clockwise or counter-clockwise or either direction 36 at different times.

FIGS. 8A and 8B show an inner/outer configuration with one ring of magnets on the stator, and one ring of magnets on the rotor. FIG. 9 shows an inner/outer configuration with multiple rows and rings of magnets both on the stator 34 and rotor 32. More magnets in the configuration may produce higher torque, or higher speed of rotation, or both. Although FIGS. 8A, 8B and 9 show both the stator and rotor magnets to be in a regular pattern, the lateral spacing and number of magnets on the rotor need not match up to those on the stator, nor be in any particular arrangement, except that the position of each stator magnet ring path will usually be aligned with a rotor magnet ring path, so that they can approach each other closely enough for magnetic forces to interact.

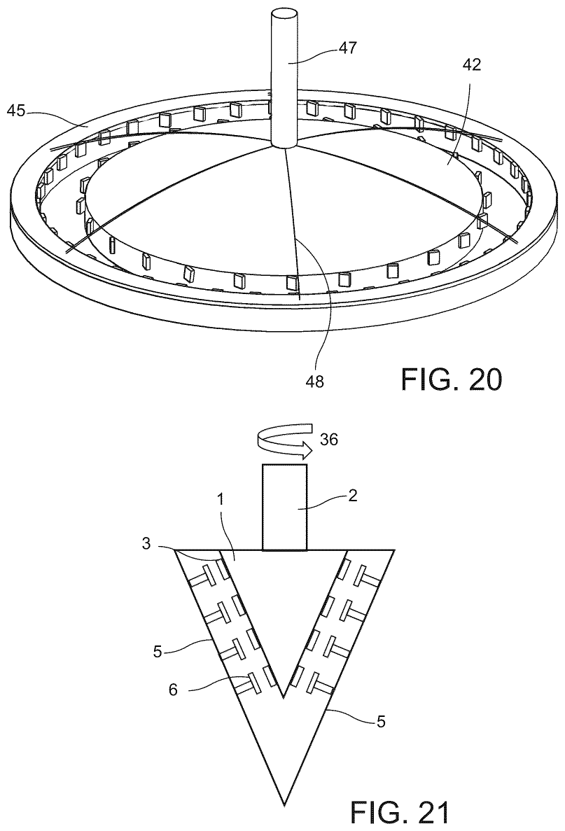

FIGS. 19 and 20 show an outer/inner configuration, with the stator actuated magnets 41 located on the outside of a stator disk 42 along its perimeter 40, or on the curved outer surface 40 of a stator cylinder 42, with polarity of each stator magnet 41 facing radially outwards, towards the magnets 44 of the rotor 45. The rotor 45 structure is a ring or tube surrounding the stator 42, with magnets mounted on the rotor's inner surface 46, with polarity facing radially inwards, towards the magnets 41 of the stator. The rotor is connected to a shaft 47 with a connecting structure 48 and imparts torque to the shaft 47 as the rotor spins in a clockwise or counter-clockwise direction 49. In the case of the rotor being a cylinder, multiple rings of stator magnets can be stacked inside the cylinder (similar to FIG. 9), and multiple rings of rotor magnets may be placed along the inside of the cylinder, thereby further increasing the torque forces imparted to the rotor's shaft (cylinder). In this manner, a very large torque could be imparted to a small diameter shaft, creating a motor that is narrow and constant in diameter, and increases in length to increase torque.

In each of the configurations described so far, the collective rotor magnets travel in 2 dimensional paths. Alternatively, the rotor magnets can be configured to trace paths which create a 3 dimensional surface, such as the surface of a cone, see FIG. 21. In a cone embodiment, the stator magnets would be configured such that at least one stator magnet faces and correlates with each rotor magnet path, either outside of the cone surface if the rotor magnets face outwards from the cone (as in FIG. 21), or inside of the cone surface, if the rotor magnets face into the cone. The stator magnet configuration could include many magnets covering the stator surface, or one line of stator magnets with only one stator magnet correlating with each rotor magnet path, or any amount of stator magnets in between those two configurations. Other 3 dimensional shapes can be imagined, such as a cylinder (i.e. as shown in FIG. 9), hourglass shape, or spindle shape. The rotor can be a long cylinder, resembling a rolling log.

Actuation of the stator magnets in each of the rotor/stator configurations shown in the Figures can be accomplished using various actuation methods. Linear actuators 20 as shown in FIGS. 10A and 10B can be used, which can push a magnet 6 away from a base position (FIG. 10B) to an extended position (FIG. 10A), and pull the magnet 6 back to the base position, in a linear path 23. FIG. 10C shows an exemplary linear actuator with magnet in more realistic detail. Details of how the linear actuator is powered are not shown.

Alternatively, rotary actuators can be used, as shown in FIGS. 11A and 11B. A permanent magnet 26 is mounted on and roughly tangent to the curved surface 29 of a cylindrical rotary actuator 21. Details of how the rotary actuator is powered are not shown. The rotary actuator revolves in a direction 24 along its axis 19, thus moving one magnet 6 towards and/or away from the rotor magnets. Each rotary actuator can have more than one permanent magnet 26, 27 mounted in locations on its curved surface. These multiple magnets mounted on the curved surface of a rotary actuator can be configured to have the same polarity when the rotary actuator makes a partial rotation, causing one of the magnets to revolve to the top position. These multiple magnets can alternatively be configured to have opposite polarities, so that one rotary actuated magnet 26 exerts a repelling/pushing force on the rotor magnets when it is positioned at or near the closest position, and another rotary actuated magnet 27 exerts an attracting/pulling force on the rotor magnets when it is positioned or near the closest position.

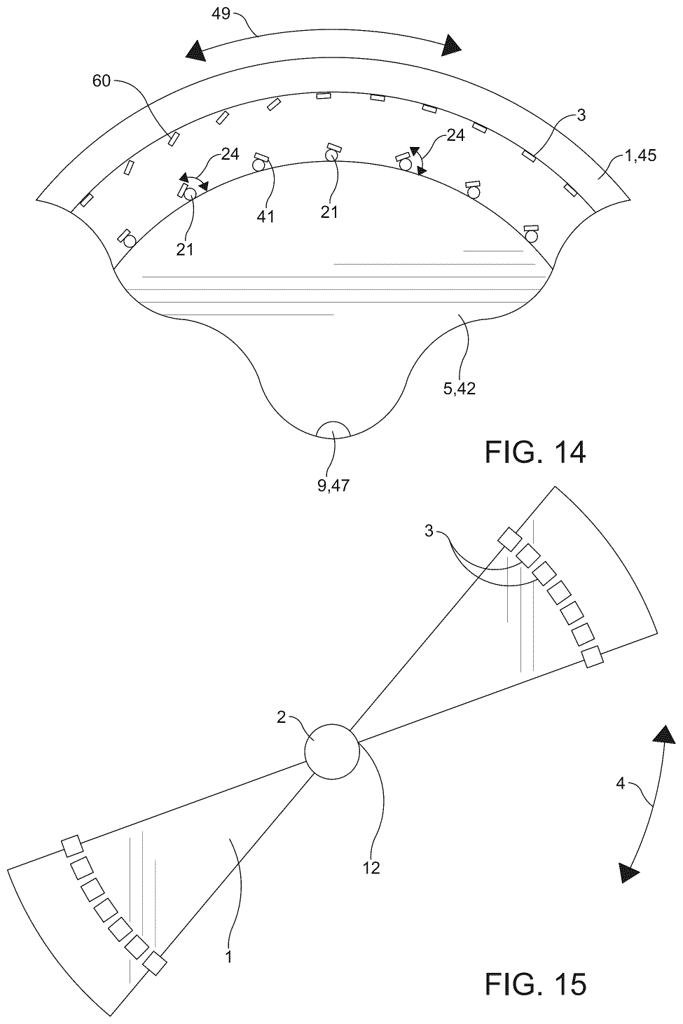

In one embodiment, when the stator/rotor magnet configuration is made up of rings on parallel planes, as in over/under or under/over configurations, the axes of the rotary actuators 31 can be oriented radially to the rotor shaft's 2 axis 9 as shown in FIGS. 13A-C, where the rotary actuator axes point in and out of the page. In another embodiment, when the stator/rotor magnet configuration is made up of inner and outer rings, the axes of the rotary actuators are oriented parallel to the rotor axis, as shown in FIG. 14, where all of the axes point in and out of the page.

FIGS. 12A and 12B show an alternate rotary actuator/magnet configuration, with permanent magnet 28 mounted on a shaft 19 which protrudes from a base of the cylindrical actuator 22, along its axis 19. The direction of the magnet's poles points perpendicular to the shaft 19. The rotary actuator and shaft 19 revolve in a direction 24, causing the magnet 28 to spin and the direction of its poles to reverse, flipping the direction of the magnetic field. This allows a stator magnet to exert a pull as a rotor magnet approaches, and a push as the rotor magnet revolves away, similar to FIGS. 13A-13C. When using this actuator configuration, the stator magnets can be positioned close to and directly under the rotor magnets.

When the stator/rotor magnet configuration is over/under or under/over, in rings on parallel planes, the axis 19 of each rotary actuator 22 with side shaft mounted stator magnet is oriented radially to the rotor axis, similar to FIGS. 13A-C. When the stator/rotor magnet configuration is inner/outer or outer/inner, the axis 19 of each rotary actuator with side shaft mounted stator magnet is preferably oriented parallel to the rotor axis, similar to FIG. 14.

In alternatives to or combinations with the linear and rotary actuators already described, actuations of the permanent magnets may be effected by electric power, pneumatic power, hydraulic power, the excitation of electroactive polymers, springs, combustion, expanding gases, electromagnet actuators, electrostatic actuators, or any other means that results in a controllable expansion and contraction motion. In any of these embodiments, electromagnets may be used as the means to impart forces to the permanent magnets on the rotor. Furthermore, electromagnets may be used in combination with one or more methods of actuating permanent magnets, such that the electromagnet forces generated are additive to any magnetic forces applied by the actuated permanent magnets.

The shaft can have different structures and designs, such as a solid shaft, a hollow core shaft, multiple concentric posts, and varying diameters, as non-limiting examples.

In any of these embodiments, the rotor can be permanently attached to the shaft, so that rotation of the rotor causes the shaft to rotate at the same rate. Alternatively, gears can be involved, to cause the rotation rate of the rotor to differ from the rotation rate of the shaft, based on the size and number of gears connecting rotor to shaft. A mechanism can be present to engage and disengage the rotor with the shaft, for example to allow torque to be applied while engaged, and to allow the shaft to spin freely when disengaged. The stator can cause both clockwise or counter-clockwise rotation of the rotor, or the system can be configured to enable only one or the other direction. The stator can cause the rotor to move in a reciprocating fashion, imparting force to the shaft and connected component, machine, engine, motor or generator when moving in a clockwise direction as well as when moving in a counter-clockwise direction.

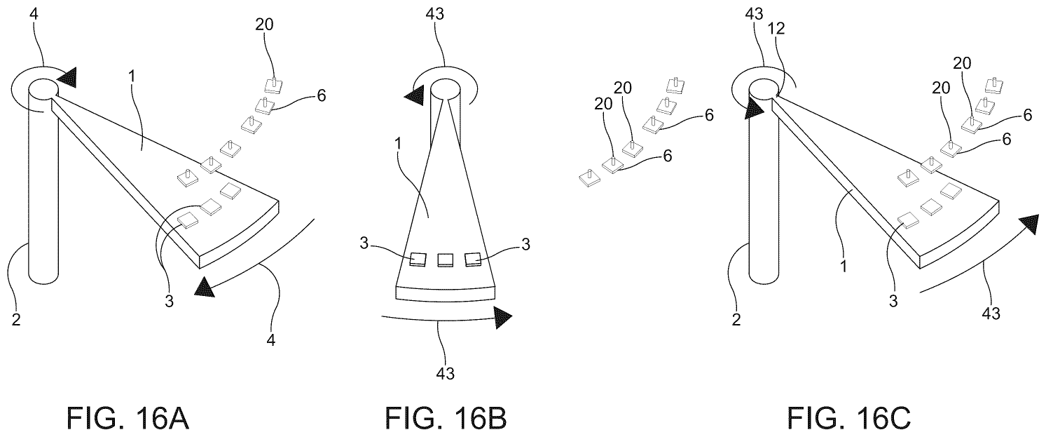

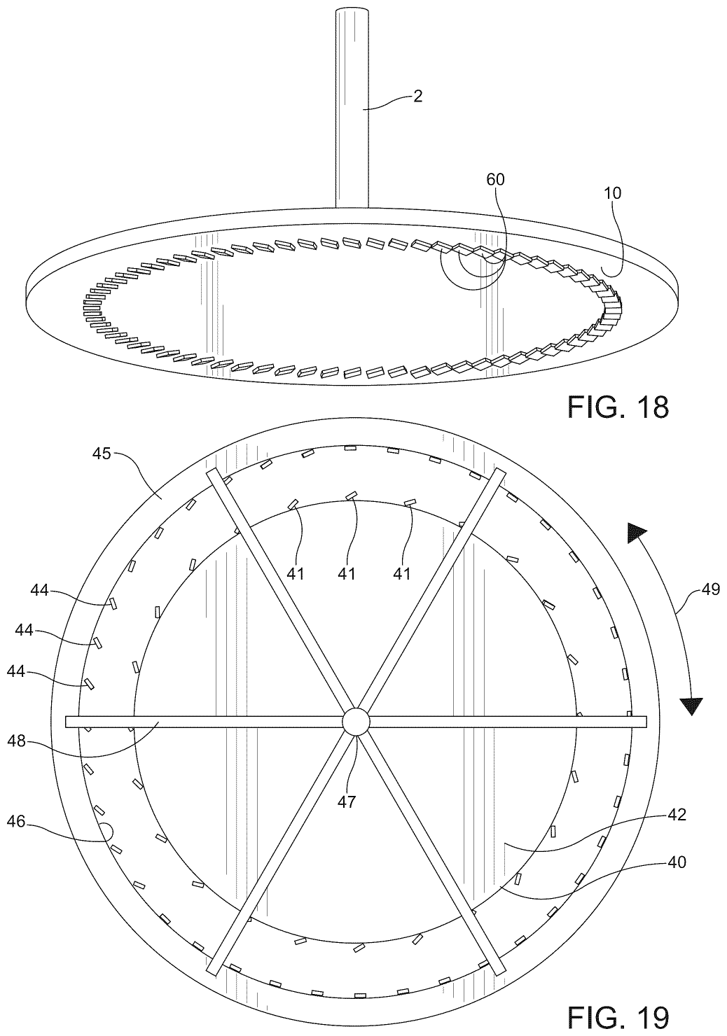

Alternatively, rotor and shaft can be connected with a mechanism that allows reciprocating motion, enabling the rotor to exert torque on the shaft when the rotor rotates in a first direction, and allowing the rotor to not exert any torque on the shaft when the rotor rotates in the opposite direction. In such a reciprocating configuration, as shown in FIGS. 16A, 16B and 16C, the rotor can be configured so that its movement is restricted to a bounded arc. The shape of such a reciprocating rotor can be one arm or sector, as shown in FIGS. 16A-16C, or two opposite arms or sectors, as shown in FIG. 15, or other shapes, including a full disk as in FIGS. 7 and 18. These shapes can be useful in a motor with space constraints which do not allow for a full rotating disk as a rotor.

The reciprocating rotor can have arms/sectors which remain in a constant configuration with respect to each other; or there can be multiple rotor arms which can move independently of one or more of the other rotor arms. In a configuration with independently moving rotor arms, sets of stator magnets can apply force to each rotor arm at different times, for example timed to apply collectively more consistent torque forces over time, as opposed to a simple default periodic push/return torque/no torque oscillating pattern.

A reciprocating configuration can have an engagement mechanism and return mechanism, which are not illustrated in the figures, but would likely be located at 12 (see FIGS. 15-16C. This engagement mechanism allows engagement and power transfer in one direction (clockwise or counter-clockwise) (FIG. 16A) and disengagement in the other direction (FIGS. 16B and 16C), and can be installed at the location where rotor meets shaft, see location 12 in FIGS. 15 and 16C, or at some other location on the shaft, for example at the location the shaft connects with the structure it is powering (not shown). The rotor/shaft engagement mechanism can be a toothed gear and pawl, a toothless gear with high friction surface and pawl, or another mechanism, that can release the shaft, allowing the rotor to impart torque to the shaft 2 or powered structure as the rotor travels in one rotational direction, and allowing the shaft or powered structure to spin freely with momentum as the rotor returns in the opposite rotational direction. The return mechanism can be implemented with stator magnets, or it can be a spring, elastic band, pneumatic or hydraulic return, or other return mechanism.

A stator can have actuated magnets at positions corresponding to multiple rotor magnet path radii, and can be made to drive multiple rotors at the same time. For example, two rotors above the stator, each having a different magnet path radii. As another example, multiple reciprocating rotors which travel in partial arcs, and may have the same or different magnet path radii, all driven by one stator. As another example, one rotor above the stator and one below the stator. Conversely, one rotor can be driven by multiple stators, for example with each stator tilted at a different angle.

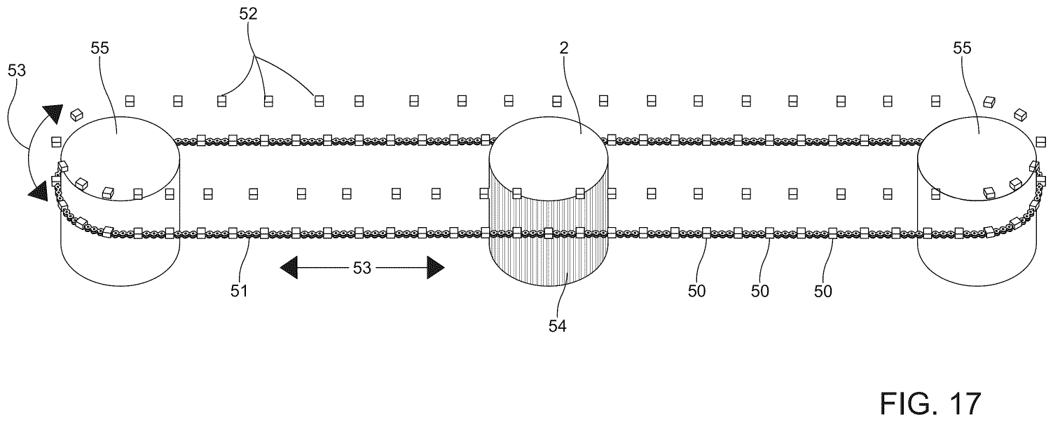

In another embodiment, shown in FIG. 17, the structure of the rotor can be similar to a chain drive. Rotor magnets 50 are mounted on a chain 51, and stator magnets 52 are mounted in positions where they can interact with the rotor magnets, providing lateral force so that the chain travels along its path in a direction 53, and exerts torque on the shaft 2, through a connecting mechanism like a toothed gear 54 surrounding and connected to the shaft. Other connecting mechanisms between chain and shaft can be used. The chain is kept on a configured path with idler-wheels 55 or other mechanisms. Alternatively, or in addition to rotor magnets attached to the chain, rotor magnets can be mounted on one or more gears or sprockets, which engage the chain, which in turn drives a sprocket or gear connected to the shaft. The possible shapes and sizes of a chain drive are extremely customizable so as to accommodate space (both size and shape) constraints and provide desired amounts of torque.

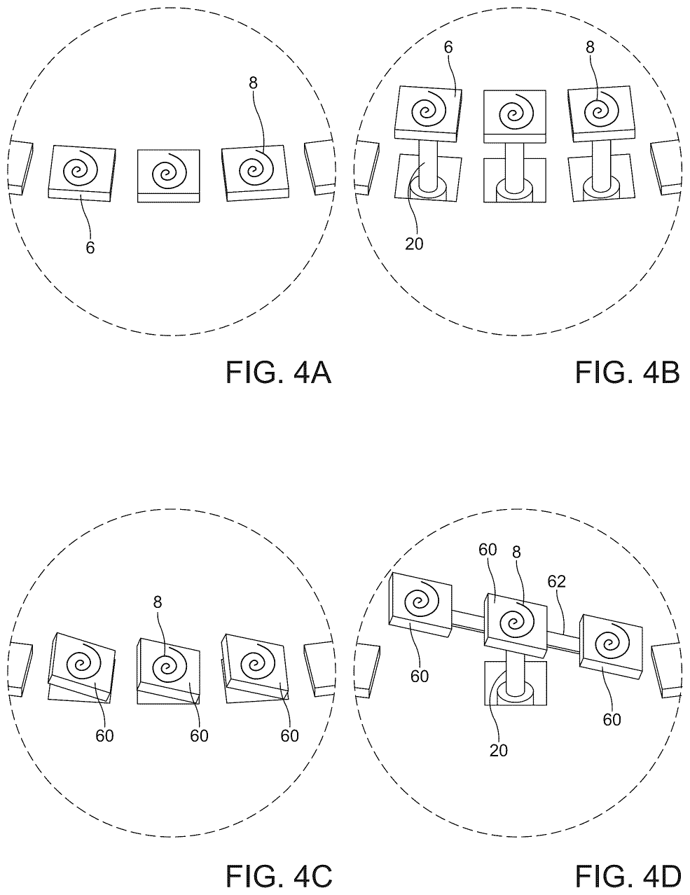

FIGS. 1A-3 and 5-9 show the rotor and stator magnets having roughly parallel poles in relation to each other. Alternatively, some or all of the rotor magnets or stator magnets or both can be angled in relation to each other, for example like vanes of a windmill, as shown in FIGS. 4C, 4D, 18, 19 and 20. Various mounting angles and configurations will have different effects. Various actuation methods (for example as shown in FIGS. 4A, 4B, 4D, and 10A-12B) may be used. Each configuration can provide a set of advantages for varying applications. For example, angled rotor magnets like those shown in FIG. 18 labeled 60 approach and are pulled in a rotational direction towards opposite-polarity stator magnets until they nearly touch, and then the stator rotary-actuator mounted magnets are spun around, similar to FIGS. 13A-13C, so that same-polarity stator magnets when actuated (rotated) are very close to and nearly touching the rotor magnets, so that the rotor magnets are repelled in the same rotational direction.

The stator and rotor can be physically connected with a connecting component, or they can be independent components, not physically touching at all. When no permanent physical connecting component is involved, the stator and rotor can be separated, thereby allowing for either the stator or rotor to be replaced or upgraded independently. The stator and rotor can be electrically and physically isolated, and thermally insulated from each other with an air gap, or through other means.

Electromagnets 8 can be added to the actuating permanent magnets on the stator, and the combined stator electromagnets and actuated permanent magnets can together apply forces on the permanent magnets on the rotor. As shown in FIG. 10C, an electromagnet can be paired with an actuated permanent magnet without being actuated linearly or rotationally. As shown in FIGS. 10A and 10B, the electromagnet could be actuated along with the permanent magnet. Electromagnets can operate (generate magnetic fields) at higher speeds and frequencies than actuated permanent magnets, while the permanent magnets actuating at slower speeds apply stronger forces. As a result, the combination of electromagnets and actuating permanent magnets together create a system that can act as a high rpm motor or a low rpm, high torque motor system. Furthermore, the inclusion of electromagnets enables smoother motion of the rotor, as the higher speed actuations help to provide more consistent forces.

As shown in FIG. 4D, multiple magnets in separate locations in the stator's ring of magnets can be mounted to the same actuator, thereby achieving coordinated actuations. Furthermore, each magnet location may itself be composed of an array of magnets such that a single actuator actuates multiple arrays of magnets. Symmetry within the permanent magnets mounted to the spinning structure (rotor) allows for symmetric forces to be imparted to the rotor at multiple points, with a single actuating mechanism, or with fewer actuators than stator magnets. In this manner, fewer actuating mechanisms (such as motors) are needed. In the embodiment shown in FIG. 4D, several stator magnets 6 in one sub-quadrant of the spin path are actuated together by one linear actuator 65. Alternatively, joined pairs of actuating magnets can be offset 180 degrees from each other, and lifted together. Alternatively, all stator magnets can be lifted by one or two actuators. Alternatively, a quartet of magnets, each offset 90 degrees from each other in the spin path, can be actuated together. Alternatively, each actuator can lift an array of magnets.

A stepper motor with strong torque may be implemented with the elements of this invention, wherein the rotor moves in a partial rotation, stops at a pre-set point, and is held still at the pre-set point with force. Attractive magnetic forces, repulsive magnetic forces or a combination may be caused by the stator magnets to propel or drag the rotor to its new position, and then strongly attract one or more of the rotor magnets to the pre-set position and prevent the rotor from moving, or use a combination of repulsive forces to hold the rotor in the pre-set position.

Each rotor/stator configuration described herein, such as over/under, under/over, inner/outer or outer/inner, has been described and illustrated with the rotor inhabiting a horizontal plane, with a vertical axis. Each of these configurations can also work with the rotor inhabiting a vertical plane, with a horizontal axis, or a plane and axis which are tilted to some degree in between horizontal and vertical.

Rotor magnets can be actuated using any of the actuation methods and structures described herein. Actuated rotor magnets can be used in conjunction with actuated stator magnets. Actuated rotor magnets can be used in conjunction with non-actuated stator permanent magnets. Electromagnets can be added to the rotor and/or the stator.

Power is proportional to torque*rpm. If we assume a stator and rotor with a single ring of magnets on each, at a distance R from the axle, with spacing D in the rotor magnets, then the amount of torque due to each rotor magnet is proportional to R²*(#magnets in rotor). In this case, the number of magnets in the rotor is proportional to the circumference of the rotor ring, and therefore proportional to R. Therefore, in this case, torque is proportional to R³. Torque increases with increased actuation range and actuation speed of the actuated magnets. Increased actuation range allows the system to lower torque exerted in the opposite direction of rotation and maximize torque exerted in the direction of rotation by more fully extending and retracting magnets. Increased actuation speed similarly enables the system to put magnets in the goal position as quickly and for as much time as possible. Increasing the density of non-actuated magnets, either on the rotor or stator, will not necessarily increase torque, as it may increase the amount of torque exerted opposing the direction of rotation more than it increases the amount of torque exerted in the direction of rotation. A higher density of actuated magnets may also cause unwanted interactions between stator magnets as they actuate in relation to each other.

Stator magnets 6 and rotor magnets 3 can be implemented by one or more magnets, for example, a permanent magnet or magnets (in any pattern or configuration), an arrangement of magnets, such as a Halbach array, a mix of permanent magnets having the same or different physical properties, orientations, magnetic properties, etc., an electromagnetic coil or electromagnetic coils (in any pattern or configuration), a mix of permanent magnets and electromagnetic coils, or combinations thereof, etc.

Stator actuations can be optimized for each application. The timing of actuations can be based upon simple preprogrammed timing, or more commonly incorporate a feedback method, which senses rotor angular position and angular velocity, and use these to determine how, when and how quickly to actuate each stator magnet. and/or performance and continues actions which improve performance. In one control scheme, model predictive control (MPC) is used to dynamically adjust actuating frequencies (of electromagnets and actuating permanent magnets) field strength (electromagnets), speeds, and heights to optimize for torque, rotational speed, and/or energy efficiency. Additional methods can use data gathered from sensors to improve the system in efficiency, power, torque, speed control, noise, longevity, and heat dissipation, of the system.

We claim:

1. A motor, comprising:
a rotor and shaft with one or more permanent magnets configured on said rotor at a rotor magnet radius distance away from said shaft, said rotor being configured to spin so that said one or more rotor magnets travel in an path; and
a stator with one or more actuated magnets placed in a configuration along at least a portion of said rotor magnet path, at a stator magnet radius distance from said shaft; and
wherein said stator magnets are configured to move towards and away from said rotor magnets; and
wherein said movement of said stator magnets is configured to cause magnetic forces between said stator magnets and rotor magnets, causing said rotor and shaft to spin.

2. The motor of claim 1, wherein said one or more stator magnets are arranged in a plane, at a first stator magnet radius distance; and
wherein said one or more rotor magnets are arranged at a first rotor magnet radius distance in a plane which is parallel to said stator magnet plane; and
wherein said first stator magnet radius distance is equivalent to said first rotor magnet radius distance.

3. The motor of claim 1, wherein said one or more stator magnets are arranged in a plane, at a stator magnet radius distance; and
wherein said one or more rotor magnets and path are in the same plane as said one or more stator magnets; and
wherein said rotor magnet radius distance is not equivalent to said stator magnet radius distance.

4. The motor of claim 2, wherein said one or more rotor magnets are configured at a plurality of rotor magnet radius distances from said shaft, so that said rotor magnets travel in a plurality of paths when said rotor spins; and
wherein one or more of said one or more stator magnets are configured along each of said rotor magnet paths.

5. The motor of claim 3, wherein said one or more stator actuating magnets are arranged in a plurality of planes;
wherein said one or more rotor magnets are arranged in a plurality of planes; and wherein each said rotor magnet plane corresponds to a said stator magnet plane.

6. The motor of claim 1, wherein the rotor and stator are not directly physically connected to each other.

7. The motor of claim 1, wherein a plurality of said stator magnets are actuated by a single physical actuator.

8. The motor of claim 1, wherein said rotor and shaft connects to a component, machine, engine, motor or generator; and
wherein an engaging/disengaging mechanism is configured to allow said rotor to drive and impart torque and power to said component, machine, engine, motor or generator while engaged, and to move without affecting said component, machine, engine, motor or generator when disengaged.

9. The motor of claim 1 wherein one or more of the one or more stator magnets comprise an electromagnet coupled with a permanent magnet.

10. The motor of claim 9 wherein each stator electromagnet stays in place, and is configured to impart a combined magnetic force with its coupled actuated permanent magnet on the one or more rotor magnets.

11. The motor of claim 1, wherein the combined paths of the one or more rotor magnets form a symmetrical non-planar topological surface, called the rotor path surface; and
wherein the one or more stator magnets are configured in a stator pattern which is geometrically similar to the rotor path surface.
